(19) United States
(12) Patent Application Publication
(10) Pub. No.: US 2013/0223667 A1
(43) Pub. Date: Aug. 29, 2013

(54) TERMINAL HAVING SPEAKER UNIT

(71) Applicants: Young Wook KIM, Seoul (KR); Jim Hwan SHIN, Seoul (KR); Ju Sik LEE, Seoul (KR)

(72) Inventors: Young Wook KIM, Seoul (KR); Jim Hwan SHIN, Seoul (KR); Ju Sik LEE, Seoul (KR)

(73) Assignee: PANTECH CO., LTD, Seoul (KR)

(21) Appl. No.: 13/618,080

(22) Filed: Sep. 14, 2012

(30) Foreign Application Priority Data
Feb. 29, 2012 (KR) 10-2012-0020996

(51) Int. Cl. H04R 1/02

(52) U.S. Cl. 381/333; 381/332

(57) ABSTRACT

Provided is a terminal including a body unit including a first area and a second area partitioned from each other, a speaker unit disposed in at least one of the first area and the second area, and a cover unit fixed to a surface of the body unit by a fixing member so as to cover the first area and the second area. The fixing member may include a fluid communication unit that connects the first area and the second area in fluid communication, so that the first area and the second area are provided as a resonance chamber of the speaker unit.

### CROSS-REFERENCE TO RELATED APPLICATION

This application claims priority from and the benefit under 35 U.S.C. §119 of Korean Patent Application No. 10-2012-0020996, filed on Feb. 29, 2012, which is hereby incorporated by reference for all purposes as if fully set forth herein.

### BACKGROUND

1. Field

Exemplary embodiments of the present invention relate to a terminal equipped with a speaker unit in communication with a resonance chamber.

2. Discussion of the Background

Terminals exchange signals so that a user and another party may communicate. Terminals may include devices such as a cell phone, a personal communication service (PCS), a is personal digital assistance (PDA), a tablet computer, and the like. Mobile terminals may include various input systems such as an operation panel, a touch panel, and the like.

Generally, terminals are equipped with a built-in speaker. For the speaker, a closed-box speaker is usually employed, and is generally blocked off of a terminal and includes a separated resonance chamber for providing higher audio quality. According to development of the communications industry, various additional functions are being added to the terminals. At the same time, the terminals are becoming smaller and slimmer to improve usability and appearance. Accordingly, since various built-in components are provided in the terminals, securing a space for resonance of the speaker is becoming increasingly difficult. Lack of space for resonance may reduce audio quality of the speaker of the terminal.

### SUMMARY

Provided is a terminal in which audio quality of a speaker unit may be improved by providing a resonance chamber in fluid communication with the speaker unit and disposed throughout the terminal.

Additional features of the invention will be set forth in the description which follows, and in part will be apparent from the description, or may be learned by practice of the invention.

Exemplary embodiments of the present invention provide a terminal including a body unit including a first area and a second area partitioned from each other; a speaker unit disposed in at least one of the first area and the second area; a cover unit disposed on a surface of the body unit to cover the first area and the second area; and a fixing member to fix the cover unit to the surface of the body unit, the fixing member including a fluid communication unit to is connect the first area and the second area in fluid communication.

Exemplary embodiments of the present invention provide a terminal including a speaker unit to output a sound; a display unit to display an image; a first support frame in which the speaker unit is disposed; a second support frame in which the display unit is disposed; and a resonance chamber disposed in both the first support frame and the second support frame.

Exemplary embodiments of the present invention provide a terminal including a speaker unit to output a sound; a display unit to display an image; a cover unit disposed to cover the speaker unit and the display unit; and a resonance chamber in fluid communication with the speaker unit and disposed between the display unit and the cover unit.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a terminal equipped with a speaker unit according to exemplary embodiments of the present invention.

FIG. 2 is a perspective view illustrating a terminal equipped with a speaker unit according to exemplary embodiments of the present invention.

FIG. 3 is a graph comparing audio quality between a speaker according to is exemplary embodiments of the present invention and a related-art speaker.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the description, details of well-known features and techniques may be omitted to avoid unnecessarily obscuring the presented embodiments. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

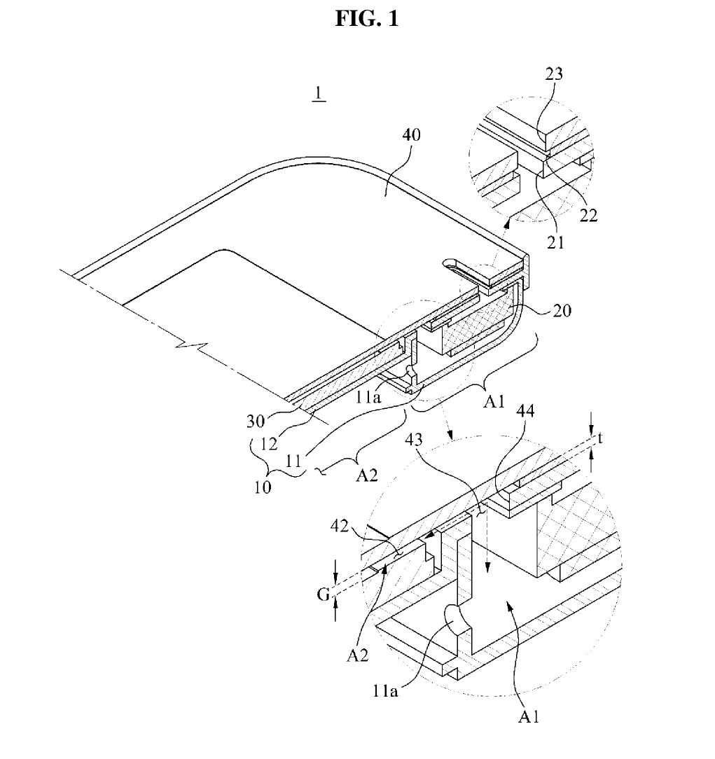

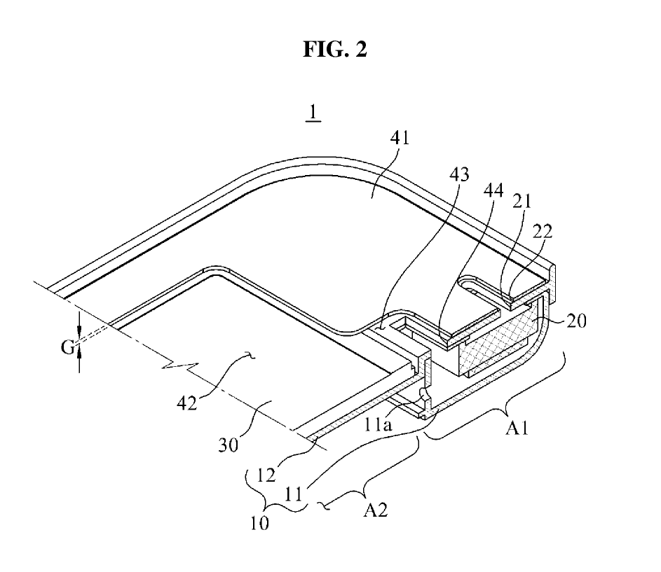

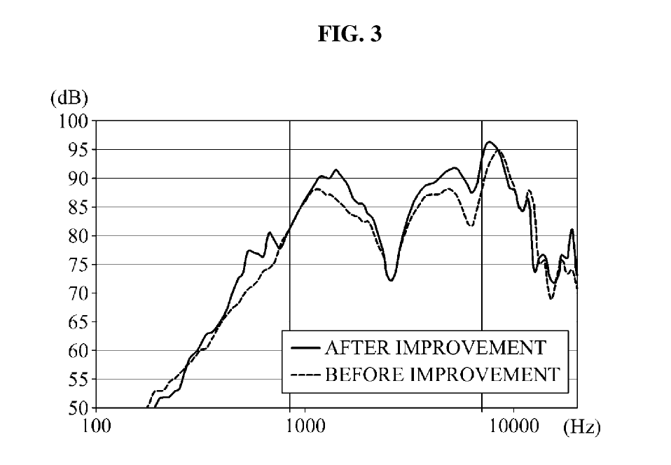

FIG. 1 is a perspective view illustrating a terminal equipped with a speaker unit according to exemplary embodiments of the present invention. FIG. 2 is a perspective view illustrating a terminal equipped with a speaker unit according to exemplary embodiments of the present invention. FIG. 3 is a graph comparing audio quality between a speaker according to exemplary embodiments of the present invention and a related-art speaker.

Referring to FIG. 1, the terminal 1 includes a body unit 10, a speaker unit 20, a display unit 30, and a cover unit 40. The terminal 1 may be a cell phone, a personal communication service (PCS), a personal digital assistance (PDA), a tablet computer, and the is like; however, aspects are not limited thereto. The body unit 10 may be a main body of the terminal 1, and may include a first area A1 and a second area A2 which may be partitioned from each other. Here, with reference to FIG. 1, the first area A1 may be a right area of the body unit 10 and the second area A2 may be disposed on the left of the first area A1 in an adjoining manner. Although the first area A1 and the second area A2 are right and left areas of the body unit 10 with reference to the drawing, when the body unit 10 is considered as having an upper, a middle, and a lower area with reference to a direction of use, the first area A1 may correspond to the upper area and the second area A2 may correspond to the middle area or the lower area, respectively. However, aspects are not limited thereto such that the first area A1 may correspond to or be disposed in a bezel area or an area between a display (i.e., a display unit 30) and a periphery of the terminal 1; and the second area A2 may correspond to or be disposed in a display area that corresponds to the display (i.e., the display unit 30) of the terminal 1. The first area A1 and the second area A2 may be partitioned by first and second support frames 11 and 12, i.e., the first and second support frames 11 and 12 may be respectively disposed in the first and second areas A1 and A2 and the first and second support frames 11 and 12 may physically separate the first and second areas A1 and A2, i.e., at least one of the first and second support frames 11 and 12 includes a divider to physically separate the first and second areas A1 and A2.

The speaker unit 20 may be disposed in at least one of the first area A1 and the second area A2 produce sound in response to an electric audio signal input. As shown in FIG. 1, the speaker unit 20 is disposed in the first area A1 of the body unit 10. The speaker unit 20 may include a closed-box speaker that generates audio signals by resonating in an enclosure-type hermetic space; however, aspects need not be limited thereto.

The display unit 30 may be disposed in the second area A2 adjoining the first area A1 and adapted to display information. Any one of various display devices may be adopted as the display unit 30. The display unit 30 may include a liquid crystal display (LCD), light emitting diode (LED) display, and/or a plasma display panel (PDP). Also, the display unit 30 may include a touch display unit to which operation signals may be input by touch.

The cover unit 40 may be fixed to one surface of the body unit 10 by a fixing member 41 to cover the first area A1 and the second area A2. As shown in FIG. 1 and FIG. 2, the fixing member 41 may be provided in a form of a plate having a thickness t to cover the first area A1 and the second area A2. The fixing member 41 may include an exposing unit 42 of which a portion facing the display unit 30 is opened so that the display unit disposed in the second area A2 is exposed. The exposing unit 42 may be a hole or an aperture disposed in the fixing member 41.

The cover unit 40 may be fixed to the body unit 10 by the fixing member 41 without interfering with an exposed state of the display unit 30 exposed toward one surface of the body unit 10. Accordingly, the cover unit 40 may protect the display unit 30 and the speaker unit 20. The cover unit 40 may be made of a transparent material so as not to interfere with exposure of the information displayed through the display unit 30. The fixing member 41 may be a dual-sided adhesive tape to attach the cover unit 40 to the body unit 10.

To transmit the audio signals to the outside of the body unit 10 of the terminal 1 through the speaker unit 20, a first speaker hole 21, a second speaker hole 22, and a third speaker hole 23 may be formed in fluid communication with one another, through the first support frame 11, the fixing member 41, and the cover unit 40, respectively, which face the speaker unit 20.

As shown in FIG. 2, the fixing member 41 may include the fluid communication unit 43 which connects the first area A1 and the second area A2 in fluid communication with is each other, thereby providing at least a portion of a resonance chamber in the first area A1 and at least a portion of the resonance chamber in the second area A2. That is, the resonance chamber may include vacant spaces in each of the first area A1 and the second area A2, and the portions of the resonance chamber in the first area A1 and the second area A2 may be in fluid communication. The portions of the resonance chamber in the first area A1 and the second area A2 may be connected by the exposing unit 42 of the fixing member 41, the fluid communication unit 43, and the fluid communication hole 44 in the first support frame 11. Here, the portions of the resonance chamber in the first area A1 and the second area A2 fluidly communicate with each other through a fluid communication hole 44 formed in the first support frame 11 at a portion of the first support frame 11 facing the fluid communication unit 43. The fluid communication unit 43 and the fluid communication hole 44 connect at least a portion of a resonance chamber in the first area A1 and at least a portion of the resonance chamber in the second area A2. However, aspects need not be limited thereto such that a structure of the fluid communication hole 44 and the fluid communication unit 43 may be altered according to a shape of the first support frame 11. The fluid communication unit 43 may be disposed between the display unit 30 and the cover unit 40. And, the fluid communication hole 44 may be formed in one or both of the first support frame 11 and the second support frame 12.

As shown in FIG. 2, because the fixing member 41 includes the exposing unit 42 and the fixing member 41 and the exposing unit 42 are shaped to open the first area A1 and the second area A2 simultaneously, open portions of both the first area A1 and the second area A2 may be provided as a rear resonance chamber of the speaker unit 20. As shown in FIG. 3, since the resonance chamber is thus secured by the fluid communication unit 43, audio quality may be improved in a medium frequency region of about 1000 hertz (Hz) to about 10000 Hz. Further, is although not shown in FIG. 3, the resonance chamber may improve audio quality of the speaker unit 20 in a low frequency region of about 20 Hz to about 1000 Hz.

Since the exposing unit 42 is formed in the fixing member 41 as a hole or aperture, the exposing unit 42 forms or provides a gap G between the cover unit 40 and the display unit 30. The gap G may correspond to the thickness t of the fixing member 41 as shown in FIG. 1. A space formed by the gap G between the cover unit 40 and the display unit 30 fluidly communicates with the first area A1 through the fluid communication unit 43, thereby forming the resonance chamber. The gap G between the cover unit 40 and the display unit 30 may be reduced, thereby achieving the terminal 1 in a smaller and slimmer form. The gap G may be a portion of the resonance chamber and may be bound, at least partially, but the cover unit 40, the display unit 30, and the exposing unit 42 of the fixing member 41; however, aspects need not be limited thereto.

An air hole 11a to allow passage of air therethrough may be formed through the first support frame 11 in which the speaker unit 20 is mounted. The air flowing through the air hole 11a may prevent the cover unit 40 from being deformed toward the speaker unit 20 and the display unit 30 due to a pressure difference between an inside and an outside of the first area A1. Although described as being formed in the first support frame 11, aspects need not be limited thereto such that, as described above, at least one of the first support frame 11 and the second support frame 12 may include a divider to physically separate the first and second areas A1 and A2, and the air hole 11a may be disposed in that divider regardless of whether the speaker unit 20 is disposed in the first support frame 11 and/or the second support frame 12.

Although not shown, a filter member, for example, a filter made of unwoven fabric, may be mounted in or over the air hole 11a to prevent entry of foreign substances into a is portion of the resonance chamber disposed in the first frame 11 in the first area A1.

Resonance operation of the above structured terminal 1 will be described with reference to FIGS. 1 and 2.

When the speaker unit 20 supported by and/or disposed in the first frame 11 corresponding to the first area A of the body unit 10 as shown in FIG. 1 is operated, the speaker unit 20 may resonate using both the first area A1 and the second area A2 due to the fixing member 41 which includes the fluid communication unit 43 connecting the first area A1 and the second area A2, which are in fluid communication with each other, as shown in the inset of FIG. 1 and in FIG. 2. Here, the resonance chamber of the second area A2 may correspond to the gap G formed between the display unit 30 and the cover unit 40. Although the gap G is narrow and corresponds to the thickness t of the fixing member 41, and because the pressure difference between the inside and the outside of the first area A1 is compensated by the air hole 11a, the resonance chamber prevents the cover unit 40 from being deformed toward the display 30 due to a pressure difference between the inside and the outside of the terminal 1. The audio signals generated through the speaker unit 20 may be passed through the first speaker hole 21 of the first support frame 11, the second speaker hole 22 of the fixing member 41, and the third speaker hole 23 of the cover unit, in order from the speaker unit 20, and provided to the outside of the body unit 10. Although described as being disposed in the first support frame 11, aspects need not be limited thereto such that the speaker unit 20 may be disposed in the second support frame 12 or a second speaker unit 20 (not shown) may be disposed in the second support frame 12 such that speaker units 20 are disposed in both the first support frame 11 and the second support frame 12.

According to exemplary embodiments of the present invention, a resonance chamber may be expanded into an area in which a speaker unit is not installed. Thus, since the is sufficient resonance chamber is secured, increase in audio quality may be achieved.

Because an air hole for passage of air into a first area is provided, a cover unit may be prevented from being deformed toward a speaker unit and a display unit due to an atmospheric pressure difference.

A distance between the cover unit and the display unit may be reduced since deformation of the cover unit due to a pressure difference is prevented. Accordingly, a smaller and slimmer terminal may be achieved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a body unit comprising a first area and a second area partitioned from each other;
a speaker unit disposed in at least one of the first area and the second area;
a cover unit disposed on a surface of the body unit to cover the first area and the second area; and
a fixing member to fix the cover unit to the surface of the body unit, the fixing member comprising a fluid communication unit to connect the first area and the second area in fluid communication.

2. The terminal of claim 1, further comprising:
a resonance chamber disposed in both the first area and the second area.

3. The terminal of claim 2, wherein the fluid communication unit fluidly connects a portion of the resonance chamber in the first area and a portion of the resonance chamber in the second area.

4. The terminal of claim 3, further comprising:
a first support frame disposed in the first area; and
a second support frame disposed in the second area.

5. The terminal of claim 4, wherein the first support frame comprises a fluid communication hole to connect the portion of the resonance chamber in the first area to the fluid communication unit.

6. The terminal of claim 1, further comprising:
a display unit disposed in the second area; and
a resonance chamber useable by the speaker unit, wherein at least a portion of the resonance chamber is disposed between the cover unit and the display unit.

7. The terminal of claim 6, wherein the portion of the resonance chamber disposed between the cover unit and the display unit has a thickness corresponding to a thickness of the fixing member.

8. The terminal of claim 1, further comprising:
a first support frame disposed in the first area;
a second support frame disposed in the second area; and
an air hole disposed in at least one of the first support frame and the second support frame to equalize pressure between the atmosphere and open space between the cover unit and at least one of the first support frame and the second support frame.

9. The terminal of claim 1, further comprising:
a first support frame in which the speaker unit is disposed, the first support frame comprising a first speaker hole;
a second speaker hole disposed in the fixing member; and
a third speaker hole disposed in the cover unit,
wherein the first speaker hole, the second speaker hole, and the third speaker hole are disposed to align with the speaker unit.

10. A terminal, comprising:
a speaker unit to output a sound;
a display unit to display an image;
a first support frame in which the speaker unit is disposed;
a second support frame in which the display unit is disposed; and
a resonance chamber disposed in both the first support frame and the second support frame.

11. The terminal of claim 10, further comprising:
a cover unit disposed to cover at least portions of the first support frame and the second support frame; and
a fixing member disposed to fix the cover unit to the first support frame and the second frame.

12. The terminal of claim 11, wherein the fixing member comprises an exposing unit, the exposing unit being a hole disposed in the fixing member that aligns with the display unit.

13. The terminal of claim 12, wherein a portion of the resonance chamber is disposed in a space formed by the exposing unit between the display unit and the cover unit.

14. The terminal of claim 13, wherein a thickness of the space formed by the exposing unit corresponds to a thickness of the fixing member.

15. The terminal of claim 11, further comprising:
a first speaker hole disposed in the first support frame;
a second speaker hole disposed in the fixing member; and
a third speaker hole disposed in the cover unit,
wherein the first speaker hole, the second speaker hole, and the third speaker hole are disposed to align with the speaker unit.

16. The terminal of claim 11, wherein the fixing member comprises a fluid communication unit, the fluid communication being a hole disposed in the fixing member to fluidly connect a portion of the resonance chamber in the first support frame and a portion of the resonance chamber in the second support frame.

17. The terminal of claim 16, wherein the first support frame comprises a fluid communication hole disposed to connect a portion of the resonance chamber in the first support frame and the fluid communication unit.

18. The terminal of claim 11, wherein at least a portion of the resonance chamber is bound by the display unit, the cover unit, and the fixing member.

19. The terminal of claim 10, wherein the first support frame comprises an air hole to equalize pressure between the atmosphere and the resonance chamber.

20. A terminal, comprising:
a speaker unit to output a sound;
a display unit to display an image;
a cover unit disposed to cover the speaker unit and the display unit; and
a resonance chamber in fluid communication with the speaker unit and disposed between the display unit and the cover unit.
